(19) United States
(12) Patent Application Publication
(10) Pub. No.: US 2010/0145873 A1
(43) Pub. Date: Jun. 10, 2010

(54) A Mass Customizable Interactive, Multi-Faceted System For Data Collection, Processing, Analysis, Transmission, And Trading In Securities

(76) Inventors: Anil Bakaya, Melbourne (AU); Dhiraj Dylan Bakaya, Melbourne (AU); Priyanka Bakaya, Belbourne (AU)

Correspondence Address: Anil Bakaya, 333 West 57th Street, Unit 603, New York, NY, 10019, US

(21) Appl. No.: 12/162,183

(22) PCT Filed: Jan. 29, 2007
(86) PCT No.: PCT/AU07/00073

§ 371 Date: Dec. 9, 2008

(30) Foreign Application Priority Data
Jan. 27, 2006 (AU) 2006900410

(51) Int. Cl. G06Q 40/00

(52) U.S. Cl. 705/36 R; 705/37

(57) ABSTRACT

A mass customizable interactive, multi-faceted system for data collection, processing, analysis, transmission, and trading in securities comprising a multidimensional database, hardware including a network of computers, software including internet browsers and software programs, wherein variables are presented to different users to allow each user to generate personalized financial product portfolio and set filters that control the presentation of information relating to their own financial news, research and/or trading.

### FIELD OF INVENTION

The present invention relates to an active and interactive, multi-faceted automated system for analysis and trading of securities and other assets. It relates to a mass customisable system that processes market data using a multidimensional database to provide instant relevant individualised data. More specifically, it relates to a system that processes and analyses data from the financial markets to aid decision making for keeping abreast with opportunities and threats as well as portfolio management and trading.

Additionally, the present invention relates to a system which receives data into a three dimensional database comprising the dimensions of securities, investment tools and time. The database uses new investment tools apart from known investment tools. Some known and new investment tools are analysed on a moving time series apart from using existing tools. Comparisons of most of these investment tools are made in real time or at any other frequency with benchmarks or sector averages which are constantly updated. In particular, the system is customisable, providing a Do-It-Yourself service to customers by instantly transmitting relevant processed data to relevant customers on their portfolios/watch lists thus assisting them in identifying strengths and weaknesses of their portfolios/watch lists and opportunities and threats from the marketplace in a timely and transparent manner.

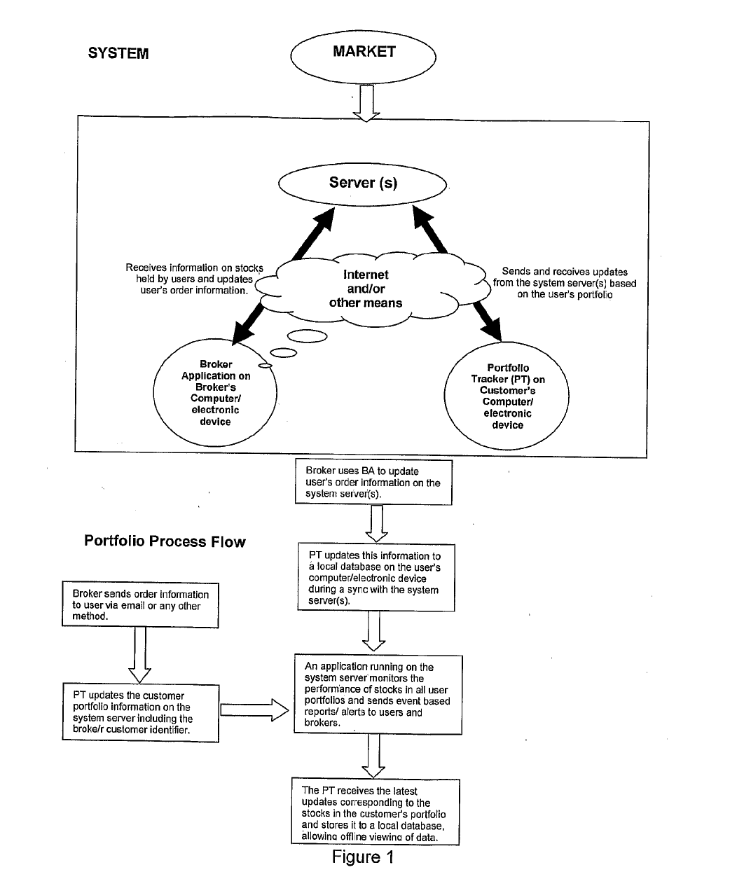

Further, the system may also be extended into a fourth dimension of customers for service and a fifth dimension to include advisers, brokers, financial planners, accountants, lawyers, trustees, as the said system includes an interface between market movements on the one hand and the user's hardware on the other hand. The user's hardware recognises portfolio details by reading information from the user's hardware memory or inbox. This facilitates a “Handshake Mechanism” between the market and the user (refer FIG. 1).

It is possible to create Sectors or Indices based on a common reference point like Global Indices, Global Sectors, Global Round Up etc. A global sector or index may mean a combination of some or all stocks with some common activities. These common activities may be gold, technology services, copper, uranium, oil, gas etc. Further, sectors or Indices may be created by customers as per their portfolios or Watch Lists etc.

Financial News as well as bullish and bearish signals are generated automatically as per novel tools like Turnover at Bid/Ask or Buyers' Market, Sellers' Market.

### BACKGROUND OF THE INVENTION

Securities including but not limited to stocks, shares, mutual funds, bonds, options, futures, commodities, American Depository Receipts (ADRs), Exchange Traded Funds (ETF's) and exchange rates fluctuate and are subject to market, industry and company specific movements and risks. Hence, everyone requires useful and frequent monitoring support and guidance as to the choices available among securities to arrive at a better-informed decision on how to allocate their investments and how to change them as per market movements.

Advice on securities or financial products in a given market may be provided by stockbrokers and other advisers, or such information may be obtained in a more general form from various newspapers, books and other literature. However, currently, a customer has little access to comprehensive and speedily available information regarding the trend or performance of a security or financial product at a point of time in real time or over any given time period as it relates to them. Further, it is currently difficult to analyze a given security as per common benchmarks or yardsticks. Without such information, it is difficult for an investor to make an informed investment decision as to the purchase and/or selling of a security. Such absence of adequate information flows leads to the so-called problem of adverse selection, or asymmetric information in the marketplace.

### PRIOR ART

### References

U.S. Pat. No. 6,415,268.

### EP 0690399A2.

U.S. Pat. No. 6,609,110
U.S. Pat. No. 6,012,044
U.S. Pat. No. 5,978,778
U.S. Pat. No. 6,049,783

U.S. Pat. No. 6,415,268 provides a method and system for investment which involves separating stock pricing data into two components: one representing the real value of a stock and the second one being the noise value of stock, the growth rate of the value function of a stock and so on. The system works on stored data and does not provide real-time value to a user.

EP 0690399A2 provides a remote financial transaction system using a payment module having access to a memory, payment account to access for performing the financial transaction and so on. The system is focused on making of payments and does not serve as a tool providing bullish/bearish signals or tips to a user while making investment decisions.

U.S. Pat. No. 6,609,110 assigned to Citibank provides a method for making investments, based on the customer's profile, portfolio and investment preferences, providing a tutorial aspect, system administration of the investment decision making. The main drawback of this system is that it tends to divest control from the customer of his account. This system reviews portfolios and alternative portfolios of a customer; however, it is not capable of reviewing a portfolio put together by customers as per their own decisions on each stock or security held.

Similarly, U.S. Pat. No. 6,012,044 relates to a system that uses risk tolerance, savings level, visual indication, slider bars, predefined volatility as criteria for estimation of value of stock or share. Other factors that directly affect investment are not fully taken into account by this system.

U.S. Pat. No. 5,978,778 have a system that analyses the stocks based on selected certain criteria. In this system, the portfolio is rebalanced at the end of an annual term and eventually, the amount of money generated by the strategies is pooled and then re-invested. The system is to be applied to large portfolios with 50 stocks and for rebalancing every year.

Another prior art system is described in U.S. Pat. No. 6,049,783 that covers an interactive system which sorts, filters and reports to retrieve valuations, sorted lists. It establishes a link with a server preset and is programmable with client criteria. The said system relates to options, their valuations, testing of scenarios etc. However, it does not fully assist investors in their decision making process as benchmarks change very often. The system is also incapable of ranking or comparing of stocks, updating clients' portfolios and making it available to their advisers on a common platform.

### Disadvantages:

1. The prior art lacks a comprehensive system that is customizable and applicable to all investors with investments of any size or number.
2. Prior art systems do not work on a real time basis and have no immediate and effective connectivity between markets and customers including the data stored in the computers of customers. Users are not provided alert access to relevant market activity. Also, their advisers/accountants/financial planners are not in real time sync with the active/interactive system in real time.
3. New or novel investment tools are not offered. Refer Pages 7 to 12 for an explanation of these novel Investment Tools
4. Price/Volume and financial news is not auto-generated on an active/interactive basis.
5. Prior art systems do not work on time series, stock comparisons with Benchmarks etc, screening/filtering and ability to navigate from stocks to sectors and vice versa.
6. These systems are not user-friendly which minimize clicks and do not assist in enabling an individual to make an informed investment decision.

### OBJECT OF THE INVENTION

It is the object of the present invention to address all the disadvantages listed above and to minimize the need of mouse clicks by users. It is also the object of the present invention to add new investment tools and further to update the new investment tools in real time or at any other frequency. Further, it is the object of the present invention to provide a mass customizable system that processes market data using a multidimensional database for generating instant relevant and individualized data.

Detailed descriptions of the preferred embodiment are provided herein; however, it is to be understood that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### DESCRIPTION OF THE INVENTION

Now, the present invention will be described with reference to the accompanying drawings wherein:

FIG. 1: shows the System Overview which includes the flow chart of Market Data processing.

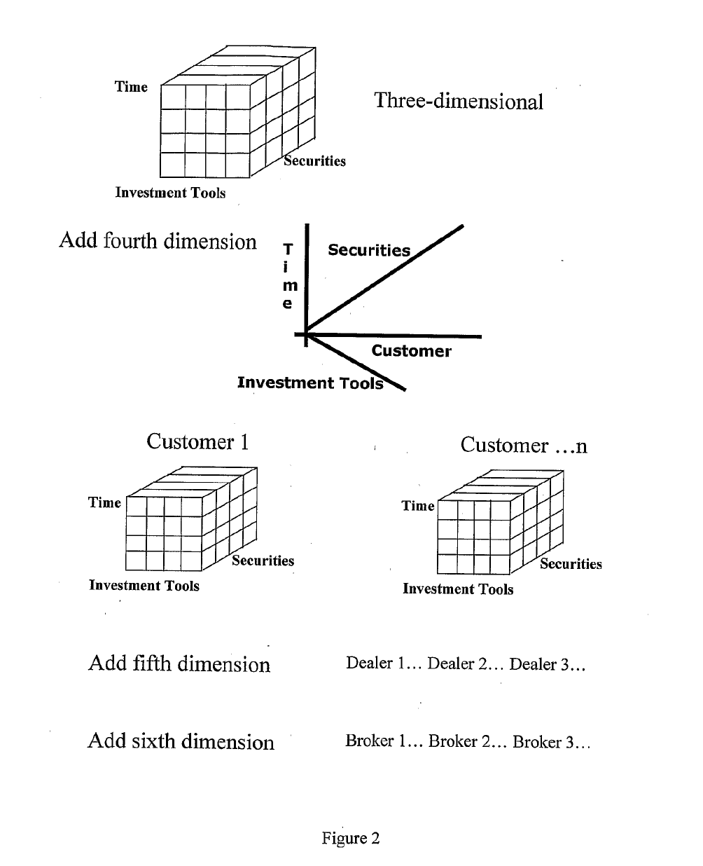

FIG. 2: shows the sample multi-dimensional database

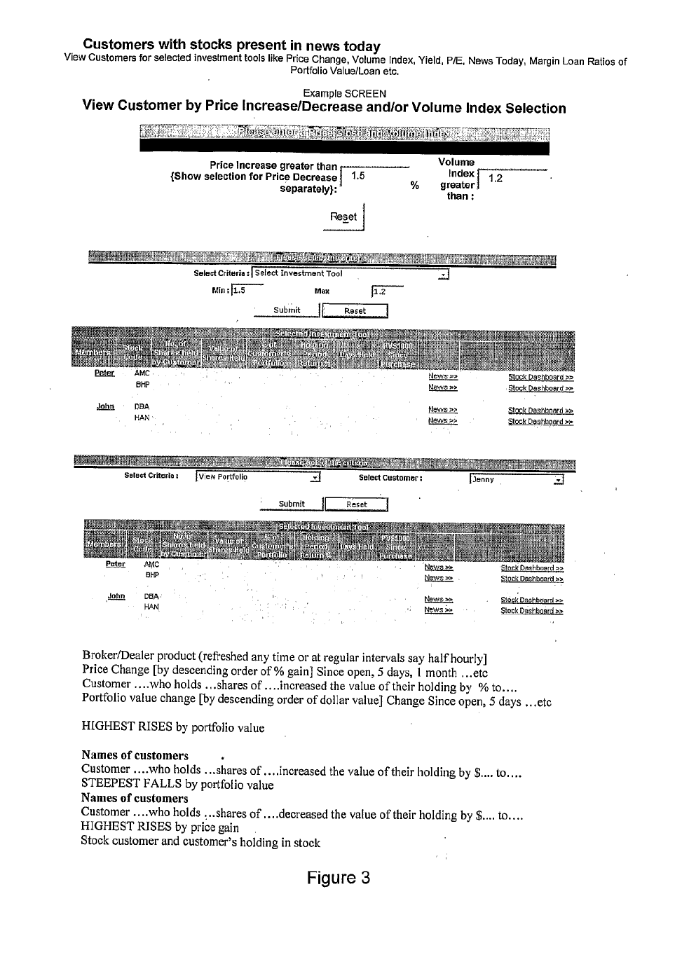

FIG. 3: shows Screenshot of the Broker/Dealer product.

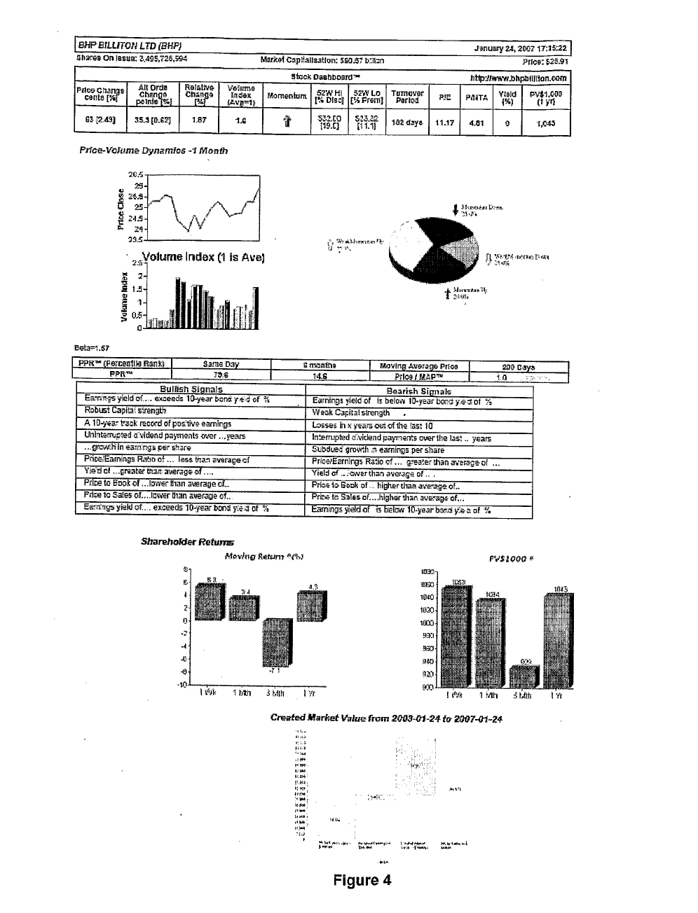

FIG. 4: shows screenshot of a Sample Stock Report generated in PDF or html updated in real time at any other frequency.

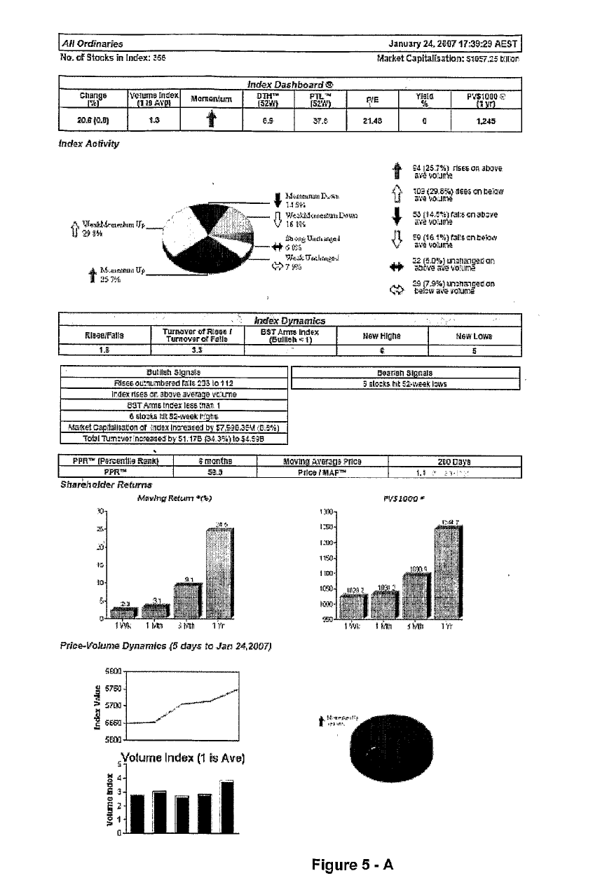

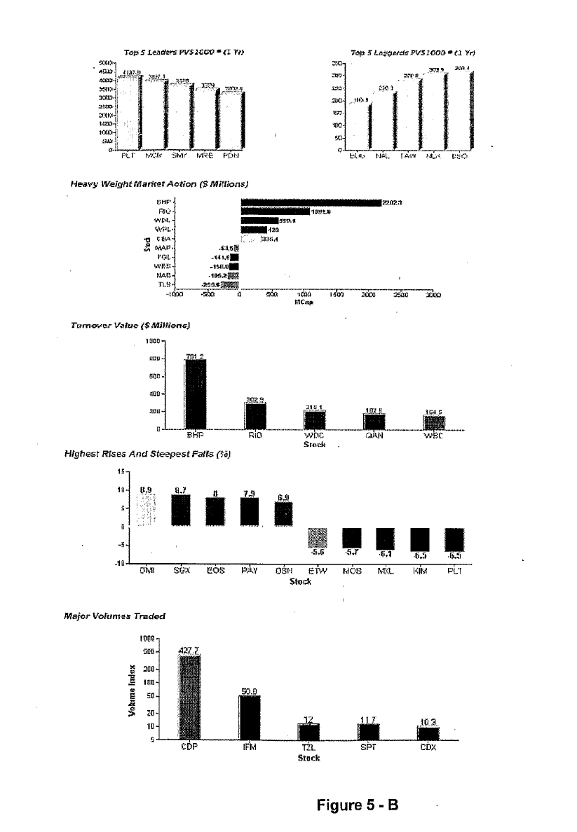

FIGS. 5A and 5B: shows screenshots of a Sample Sector Report generated in PDF or html updated in real time at any other frequency.

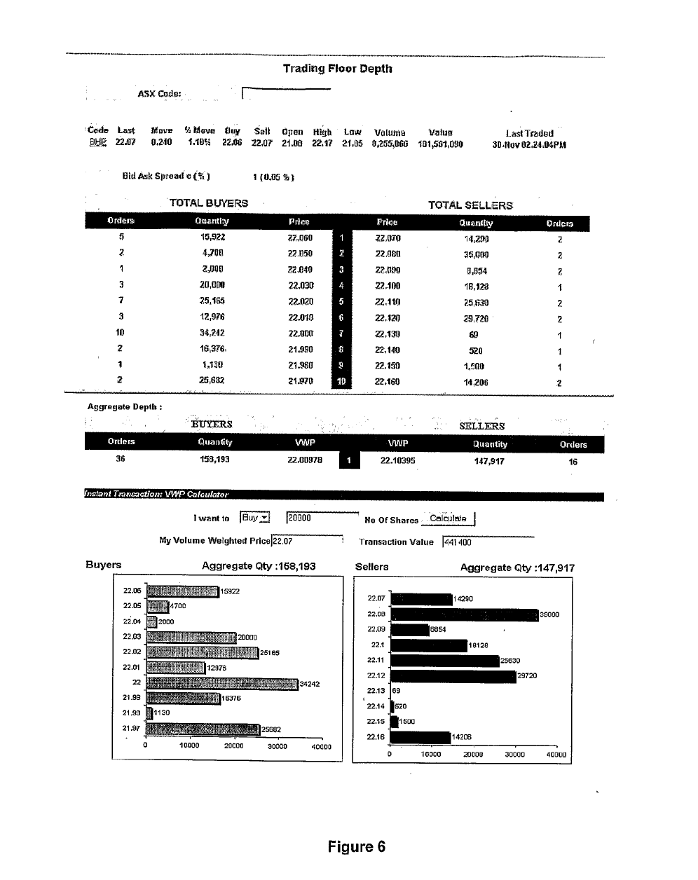

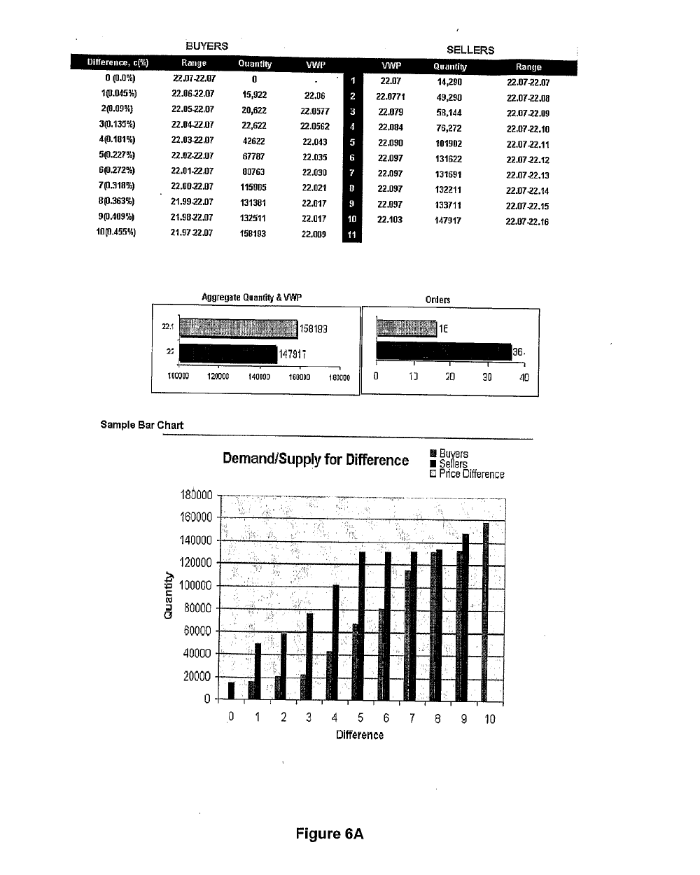

FIGS. 6 and 6A: shows screenshots of Trading Floor Depth updated in real time at any other frequency.

FIG. 7: shows screenshots of Trading Floor Dynamics updated in real time at any other frequency.

In FIG. 1 the Market information is made available to the system server (s). The system server (s) receive(s) information on stocks held by users and updates user's order information. This may be directly from the user or indirectly as per the Broker Application on Broker's computer/electronic device. The Portfolio Tracker (PT) on Customer's Computer/electronic device sends and receives updates from the system server(s) based on the user's portfolio. The Broker sends order information to user via email or any other method. PT updates the customer portfolio information on the system server including the broke/r customer identifier. In parallel to this the Broker uses Broker Application to update user's order information on the system server(s). PT updates this information to a local database on the user's computer/electronic device during a sync with the system server(s).

An application running on the system server monitors the performance of stocks in all user portfolios and sends event based reports/alerts to users and brokers. The PT receives the latest updates corresponding to the stocks in the customer's portfolio and stores it to a local database, allowing offline viewing of data.

FIG. 2: shows the sample multi-dimensional database with the first three dimensions and its extension into a fourth dimension of customers, a fifth dimension of dealers/financial planners and a sixth dimension of brokers

In FIG. 3 the Broker/Dealer product (refreshed any time or at regular intervals say half hourly) the sort of content that is shown is: information that may be ranked by Price Change or Portfolio value in descending/ascending order as per customers:

Price Change [by descending order of % gain] Since open, 5 days, 1 month . . . etc
Customer . . . who holds . . . shares of . . . increased the value of their holding by % to . . . .
Portfolio value change [by descending order of dollar value] Change Since open, 5 days . . . etc
For any or a combination of the following conditions:
HIGHEST RISES by portfolio value
STEEPEST FALLS by portfolio value

### HIGHEST LOAN/PORTFOLIO VALUE

Identify Names of customers with screening facility
Customer . . . who holds . . . shares of . . . increased the value of their holding by $ . . . to . . . .

Then, for any or a combination of the following conditions:

### STOCKS WITH HIGHEST PRICE GAIN/FALL

### STOCKS WITH HIGH BID ASK SPREAD

### STOCKS AT HIGHEST PREMIUM/DISCOUNT TO VOLUME WEIGHTED PRICE

### STOCKS IN THE NEWS/ANNOUNCEMENTS TODAY

Identify customers who hold these stocks as per Portfolios and Watch Lists

Accordingly, the invention provides an active and interactive multifaceted automated system capable of intelligently assisting a user in making a more informed decision as to the purchase or sale of a financial security. A “financial security” as used herein includes but is not limited to a claim or a security such as stocks, shares, exchange traded funds, mutual funds, commodities, exchange rates, depository receipts like ADRs, bonds, options, futures etc.

The system allows the user to synchronise their portfolio information on their local computers with the system server(s) over the Internet. The system incorporates a user-server application which is installed on the user's desktop or laptop computer/mobile phone/PDA/television/other electronic devices and connects to the system server to send and receive updates through the internet and/or other means. The system also updates new order information by synchronising with the broker's database on the system server or via e-mails and/or by other means sent by a broker to the customer. The broker may send contract notes of executed buy or sell orders to the customer which will be read by the system and connected to the market and relevant portions of the broker's database may also be synchronised with the system server(s) through the internet and/or other means.

During an update (which may be in real time or at any other frequency), the Portfolio Tracker (PT) updates the system server with the latest market data (including buy and sell orders, trades etc) and downloads relevant information corresponding to stocks in the user's portfolio. This information may contain the Stock Dashboard/Report, Sector Dashboard/Report, and numbers corresponding to the investment tools selected by the customer. The PT allows users to view this information even when the computer or any other electronic device is offline or not connected to the Internet. The user may choose to receive updates in real-time, every hour or at the end of a trading day (refer FIG. 1).

Each transaction of a customer is associated with a Broker. The Broker Application (BA) allows brokers to view the following, for example:

a. A consolidated list of securities held by their customers.
b. Positions of each individual customer (securities bought and sold by the customer).

In a manner similar to the PT, the BA connects to the system server to download information on stocks bought/sold by all customers. This could include the Stock, Market and Sector Dashboards as well as numbers from relevant investment tools chosen by the broker. An order entry screen on the BA allows the broker to update the customer portfolio information on the system server (refer FIGS. 1 and 3).

The system of the invention provides a 3-dimensional database comprising the dimensions of securities (like stocks, bonds, options, futures, commodities, exchange rates, ADRs, ETFs etc) or assets as one dimension, investment tools (or criteria or variables) as a second dimension and time as a third dimension. Market movements as they take place are monitored in this three-dimensional database with each cell corresponding to a specific security on one dimension, an investment tool on a second dimension and time as a third dimension which is moving. The invention thus provides a system which may be seen to act as a platform or apparatus comprising cells which can be directly transmitted (in real time or at any other frequency) without any clicks to relevant customers thus making opportunities or threats immediately available to customers as they apply to their pre-arranged securities and investment tools (which might exist on their individual Members Pages like “My Portfolio”, “My Watch List”, “My Transactions” or “My Self Managed Super Funds”). The platform may be shared by customers, if they wish, with their advisers. The user may create personalised information such as My Automated Email Reports, My Portfolio and My Margin Loan Account, My Holding Period Return, My Watch List, My Transactions and My Self Managed Super Fund. The basic data for the personalised information may be obtained predominantly from the user's hardware. (Refer FIG. 3 for the Broker/Dealer application).

The present invention also proposes the following novel Investment Tools:

| New | | | |
|---|---|---|---|
| Investment | Definition/Comment (for Sample Screenshots and extracts refer to | | |
| Tool | relevant portions of attached FIGS.) | | |
| Volume Index | Number of shares traded in the period/Average number of shares traded for the | | |
| | period (1 is average). Example Volume Index today is Today's Volume/Average | | |
| | number of shares traded per trading day in the last 250 trading days. (FIG. 5 | | |
| | Stock Dashboard and FIG. 6A Index Dashboard also 6B Major Volumes | | |
| | Traded) | | |
| BST Arms Index | The Arms Index (trading indicator or “trin”) named after Richard A Arms | | |
| (applied to | (Jr.) its creator measures market strength. A trin greater than 1 indicates | | |
| Sectors or | money flowing out of stocks (Bearish sign) while a trin of less than 1 | | |
| Indices) | indicates money flowing into stocks (Bullish sign). The Arms Index is | | |
| | computed by dividing two ratios | | |
| | Arms Index = [Advances/Declines]/[Advance Volume/Decline Volume] | | |
| | The BST Arms Index modifies the Arms Index by including turnover in the | | |
| | denominator instead of volume to reflect a closer impact on the money flows | | |
| | into or out of the Sector or Index. It equals [Number of rises/Number of Falls]/ | | |
| | [Turnover of stocks that rose/Turnover of stocks that fell] (FIG. 6A) | | |
| Indices of Sectors | Sectors may be created by identifying common activities of stocks in the | | |
| as per a common | sector. Indices of these sectors may be computed by a pro-rata | | |
| activity | allocation of market capitalisation of stocks as per proportion of | | |
| | earnings/revenues/assets from common activities. Also Global Indices | | |
| | may be created like GlobalGoldStocks, GlobalCopperStocks, | | |
| | GlobalOilStocks, Global Round Up on Commodities, Currencies, World | | |
| | Exchanges etc. | | |
| Momentum | Momentum Up | [symbol] | Price increase fuelled by above average |
| | | | Volume |
| | Weak | [symbol] | Price increase on below average Volume |
| | Momentum Up | | |
| | Momentum | [symbol] | Price decrease fuelled by above average |
| | Down | | Volume |
| | Weak | [symbol] | Price decrease on below average Volume |
| | Momentum | | |
| | Down | | |
| | Strong | [symbol] | Price unchanged on above average Volume |
| | Unchanged | | |
| | Weak Unchanged | [symbol] | Price unchanged on below average Volume |
| | Untraded | ◯ | Untraded |
| | (FIGS. 5 and 6 A) | | |

| | |
|---|---|
| Moving Average | Moving Average Price (MAP) is the Sum of Prices for each Period/Number of |
| Price increasing/ | Periods. If the MAP is increasing it is shown as a Bullish Signal; if it is decreasing |
| decreasing | it is shown as a Bearish Signal. For example we may compare 200-day Moving |
| | Average price today with the 200-day Moving Average price on the previous |
| | trading day to check if it is increasing or decreasing. (FIGS. 5 and 6A) |
| Price/MAP | It is a common practice to use Moving Average Price over 200 trading days or 50 |
| | trading days. If Price divided by Moving Average price is greater than 1 it is |
| | considered to be a Bullish Signal and if it is less than 1 it is considered to be a |
| | Bearish Signal. (FIGS. 5 and 6A) |
| Common Size | Current Assets (Cash, . . . ), Non current Assets, Current Liabilities |
| ratios By Market | (Current Debt, . . . ), Non current Liabilities (Non current Debt, . . . ), |
| Capitalisation. | Shareholders Equity etc. as percentage of Market Capitalisation. |
| Price Percentile | Price Close today/Price Close since open [or 6 months ago], then ranked by |
| Rank (Any pre- | percentile within the entire market (or any pre-specified sector), excluding |
| defined Sector) | suspended stocks but including last traded price if untraded. For example, a |
| | Price Percentile Rank of 40 means that the stock performed better than 40% of |
| | the Market since open [or in the last 6 months]. (FIGS. 5 and 6A) |
| Discount to High | % Discount to High for a period = (Price High for period-Last Price)/Price |
| | High expressed as a percentage. The period could be 1 day, 1 week, 52 weeks, |
| | etc. |
| | (FIG. 5 Stock Dashboard and FIG. 6A Index Dashboard) |
| Premium to Low | % Premium to Low for a period = (Last Price − Price Low for a period)/Price |
| | Low expressed as a percentage. The period could be 1 day, 1 week, 52 weeks, etc. |
| | (FIG. 5 Stock Dashboard and FIG. 6A Index Dashboard) |
| Heavyweight | The highest rises and the steepest falls in Market Capitalisation of stocks that had the |
| Market Action | most influence on the Sector Index. (Refer FIG. 6 B) |
| Turnover Period | Total Shares on Issue/Average Daily Volume of Trade (Refer FIG. 5) |

Dividend and Tax Related Tools

| | |
|---|---|
| Effective Yield | Yield to customer after accounting for their tax rate and franked dividends of the |
| After Tax | company. The effect of dividend franking the dividend imputation tax credit |
| | available and its impact on individual investors based on their applicable tax rate |
| | is provided. For example, they may be on a certain tax rate and depending on |
| | Franking credits the effective yield after tax (as well as the Absolute Yield |
| | Spread, the Relative Yield Spread and the Yield Ratio) may be more suitable for |
| | them in their circumstance. |

Tools to measure Shareholder Returns

| | |
|---|---|
| Moving Return | [Dividends paid in a 12-month period]/[Price at the beginning of the period] in |
| | % + [Capital Gain or Loss over 1 year/[Price 1 year ago] in % |
| | (FIGS. 5 and 6A) |
| PV$1000 | Present Value of $1,000 invested in an asset or security 5 years ago, 3 years ago |
| | or any other period ago. The method assumes Dividends are reinvested on the |
| | date they were paid and separately computes the components of Present Value |
| | of $1,000 as $1,000 investment, Capital Gain/(Loss), Dividends Reinvested, Total |
| | Present Value. |
| | (FIGS. 5 and 6A also 6B) |
| Created Market | Created Market Value in an asset or security over any period is updated in real |
| Value | time or at any other frequency by comparing with a reference point of N years |
| | ago where N could be any number 1 or more. For shares the Created Market |
| | Value is the current Market Capitalisation less the Market Capitalisation N periods |
| | ago divided by the sum of all Retained Earnings during those N periods. For |
| | example, if the period is 5 years the Created Market Value = (MCAP today-MCAP |
| | 5 years ago)/Sum of all Retained Earnings for each of the 5 years. |
| | (FIG. 5) |

Other Tools: Shareholders and Directors

| | |
|---|---|
| Core | Core Shareholding over a given period like 1 year, 3 years, 5 years etc. This is a |
| Shareholding & | new definition of Core Shareholdings and Float. Identify shareholdings, which |
| Float | have not changed hands over a given period such as 1 year, 3 years etc. List |
| | these and call these Core Shareholdings. Minimum holding of shareholders |
| | common to the latest Top 200 or Top 20 or any number of Top Shareholders |
| | report and the report N years ago. N reflects a long-term or non-cuurent figure |
| | of 1 year, 3 years etc The sum of all these minimum common holdings is defined |
| | as the core shareholding. The Issued Capital less the Core Shareholdings is |
| | defined as the float (expressed as a percentage of total shares on issue or as |
| | number of shares). |
| Director's | Relate a Director's performance during his or her tenure to the Moving Annual |
| Performance | Return, Return on Equity, Total Returns to Shareholders, PV$1000 (Since |
| Indicators/ | appointment), PV$1000 (over tenure or period during which the Director served) |
| Director's Score | Capital Strength or Growth/Performance indicators of the stock or to any other |
| Card | criteria included in the system. Compare key variables as on the date of their |
| | appointment with the same key variables at any given time while they are still |
| | Directors (or as at the date when they ceased to be Directors). Comparison may |
| | be made over any period when they were on the Board. |

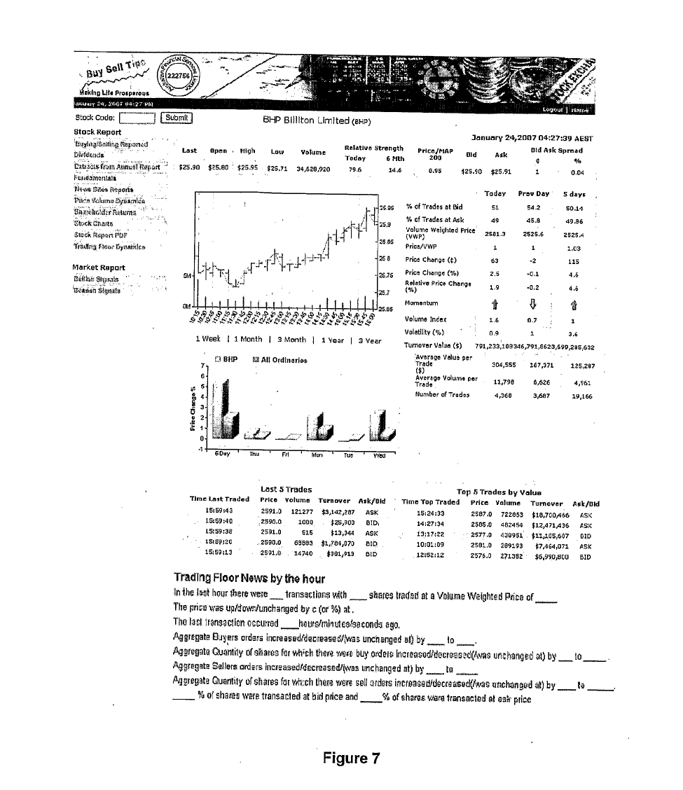

Trading Floor Tools in Real Time

| | |
|---|---|
| Turnover at Bid, | A method to do a post facto analysis on every transaction. Was it done at the |
| Turnover at Ask, | bid price or the ask price immediately prior to the transaction? Maintain a record |
| % Turnover at | of volumes and turnover transacted at bid price and at ask price. If the last price |
| Bid, | of the stock is greater than or equal to ask price immediately prior to the |
| % Turnover at | transaction tag it in one of two baskets as “Turnover at Ask” On the other hand, |
| Ask; | if the last price of the stock is less than or equal to bid price immediately prior to |
| Volume at Bid, | the transaction tag it as the second basket: “Turnover at Bid”. In other or |
| Volume at Ask, | intermediate cases, split the turnover: Turnover at Ask = Turnover × [Ask price − |
| % Volume at Bid | Last price]/[Ask price − Bid price] and Turnover at Bid = Turnover × [Last price − |
| % Volume at Ask | Bid price]/[Ask price − Bid price]. Add the turnover in two baskets viz turnover at |
| Buyers' Market | bid and turnover at ask. The total of these two figures is total turnover. Identify |
| | the percentage of volumes/turnover transacted at bid price and the % of |
| | volumes/turnover transacted at ask price. % Turnover at Bid = Turnover at |
| | Bid/Total Turnover and % Turnover at Ask = Turnover at Ask/Total Turnover. |
| | The two % amounts add up to 100%. % Turnover at Bid + % Turnover at Ask = |
| | 100%. Likewise, % Volume at Bid + % Volume at Ask = 100% of Volume |
| | If a greater amount of transactions by Volume/Turnover were at bid price (say |
| | more than 50% or a number greater than 50%), define it as a Buyer's Market. If |
| | the period of definition is Since Open today call it Buyer's Market Today. If it was |
| | yesterday call it Buyer's Market yesterday etc. (FIG. 8) |
| Turnover at Ask, | Refer to Lines 1 to 16 under Buyers' Market above. [A method . . . 100% of |
| % Turnover at | Volume] |
| Bid, | If a greater amount of transactions by Volume/Turnover were at ask price (say |
| % Turnover | more than 50% or a number greater than 50%) it is a Seller's Market. Define |
| at Ask | the period over which this happens. For example, if the period of definition is |
| Sellers' Market | Since Open today call it Seller's Market Today. (FIG. 8) |
| Demand Gap and | A method to compute the Demand gap and the Supply gap for Difference (above |
| Supply Gap for | or below last price) of the same magnitude above the last price (for ask price) |
| Difference | and below the last price (for bid price) based on depth at various levels of the |
| | screen displayed by the stock exchange or other securities exchange on buying |
| | orders and selling orders. Refer to FIGS. 7 and 7A for a screenshot on Trading |
| | Floor Depth for an illustration. |
| | In the example of FIGS. 7 and 7A: |
| | The last price was $22.07 [the last price is treated as the reference point against |
| | which the difference is computed] |
| | Total quantity available from buyers at a bid price $22.06 was 15,922 |
| | Total quantity available from sellers at an ask price of $22.07 was 14,290 |
| | So for a difference of 0 cents there were 0 shares being available from Buyers |
| | [none at bid of $22.07] and there were 14,290 shares available at ask |
| | Difference 0 cent [Buyers] = 0 shares |
| | Difference 0 cent [Sellers] = 14,290 shares |
| | Also, for a difference of 1 cents there were 0 + 15,922 shares being available |
| | from Buyers [none at bid of $22.07 plus 15,922 at bid of $22.06] and there were |
| | 14,290 shares available at ask of $22.07 plus 35,000 shares available at $22.08 |
| | ask |
| | Difference 1 cent [Buyers] = 15,922 shares |
| | Difference 1 cent [Sellers] = 14,290 + 35,000 = 49,290 shares |
| | Further, for a difference of 2 cents there were 0 + 15,922 + 4,700 shares being |
| | available from Buyers [none at bid of $22.07 plus 15,922 at bid of $22.06 plus |
| | 4,700 at bid of $22.05] and there were 14,290 shares available at ask of $22.07 |
| | plus 35,000 shares available at $22.08 ask plus 8,854 available at ask of $22.08 |
| | Difference 2 cents [Buyers] = 0 + 15,922 + 4,700 = 20622 shares |
| | Difference 2 cents [Sellers] = 14,290 + 35,000 + 8,854 = 58144 shares |
| | Likewise: |
| | Difference 3 cents [Buyers] = 0 + 15,922 + 4,700 + 2,000 = 22622 shares |
| | Difference 3 cents [Sellers] = 14,290 + 35,000 + 8,854 + 18,128 = 76272 |
| | shares |
| | These are shown in a Chart in FIG. 7 A; in this case the selling quantity is |
| | outnumbering the buying quantity at a difference of 1 cent, 2 cents and 3 cents |
| | suggesting more selling pressure than buying pressure. We treat this as a |
| | bearish signal. |
| Volume Weighted | In FIG. 7 if someone wished to buy 50,000 shares instantly, they would need |
| Price for Instant | to spend 14,290 × 22.07 + 35,000 × 22.08 + 710 × 22.09 = 772800 + 315380.3 + |
| Buying or Selling | 15683.9 = 1103864.2. Volume Weighted Price for Instant Buying = |
| | 1103864.2/50,000 = $22.077284 |
| | Likewise if someone wanted to sell 16,000 shares the Volume Weighted Price for |
| | instant selling = 15,922 × 22.06 + 78 × 22.05]/16,000 = [351,239.32 + |
| | 1,719.9]/16,000 = 352,959.22/16,000 = $22.05995125 |
| Price/Volume | Last Price divided by Volume Weighted Price [Since Open, 5 days, 1 month or |
| Weighted Price | any other period] |
| | (FIG. 8) |
| Aggregate Depth | Aggregate depth on the buy side and on the sell side (refer. Screenshot on |
| or Top Five | Trading Floor Depth for illustration in FIGS. 7 and 7A). This may be computed |
| Depth | for all or some levels for example top 5 levels, top 10 levels etc. |

“Handshake” Tools

| | |
|---|---|
| My Weighted | My Weighted Average Holding Period Return |
| Average Ratios | My Weighted Average Beta |
| Weighted as per | My Weighted Average Relative Strength (or Price Percentile Rank in a given |
| My Portfolio* | sector) |
| | My Weighted Average Relative Return |
| | My Weighted Average Yield |
| | My Weighted Average P/E |
| | My Weighted Average Price/Book |
| | My Weighted Average Debt Equity |
| | My Weighted Average P/MAP |
| | My Weighted Average P/VWP or P/VWMAP |
| | My Weighted Average Portfolio Momentum |
| | My Weighted Average Sectoral Allocation |
| | My Weighted Average Total Returns to Shareholders (TRS) |
| | My Weighted Average Volume Index and Momentum |
| | My Loan/Valuation ratio |
| | My Weighted Average PV$1000 (1 Yr) |
| Compare | Compare the above with Market Averages or Benchmarks and also make |
| | available percentile rankings. Show a favourable comparison as a Bullish Signal |
| | and an unfavourable comparison as a Bearish Signal. |
| Sectoral/Index | Sectoral allocations etc as per the weighting of the value of the user's holding in |
| allocations | the stock as a percentage of the total value of holdings of the user in all stocks |
| | or their total portfolio. These Weighted Average figures are compared with |
| | Market or Sector Averages to identify strengths and weaknesses of the Portfolio |
| | as they get affected by market conditions in real time at any other frequency. |
| My Price Volume | My Bid Ask Spread Trigger |
| Triggers | My Volume Index Trigger |
| (to receive auto | My Price Trigger |
| emails or | My Moving Average Price Turning Point Trigger |
| messages from | My New Price High/Low Trigger |
| the system) | My Price Change Trigger |
| | My Price/Volume Weighted Price Trigger |
| | My Turnover % Bid/Ask Trigger |
| | My Increase in Value per Trade |
| My Watch List | My Top Rises and Falls |
| Reports | My Major Volumes Traded |
| | My Trading Floor Report |
| | My Watch List Dynamics with ability to sort as per column headings |
| PV$1000 (Since | Present Value of $1,000 invested in an asset or security on purchase date; |
| purchase) | assumes dividends paid since purchase are reinvested at the share price on |
| | which they were paid. |
| News relevant to | News which may be converted from data to text. This may be done on the fly on |
| User | demand at any time by a user. |

*The way the weightage for a Portfolio is given is according to the individual holdings of a customer. For example if a customer holds 40% of their Portfolio in a stock with a P/E of 10, 35% of their Portfolio in a stock with a P/E of 12 and 25% in a stock with a P/E of 14 their weighted average P/E is 0.4 × 10 + 0.35 × 12 + 0.25 × 14 or 4 + 4.2 + 3.5 = 11.7.

A better and more complete understanding of the invention may be garnered from the detailed description of the preferred embodiment of the best mode of the invention as contemplated by the inventors.

In essence, one can think of each security as an object with main properties consisting of data and functions also referred to as investment tools. Each security has basic measures associated with it such as price (open, high, low, close), volume, earnings per share etc. It also carries history of these measures and has functions that can compute various derived measures such as volume index, price earnings multiples (for stocks) and other investment tools. It also knows recognizes/identifies the group (or Index or Sector) that the security is a constituent of and has functions that make comparisons with the benchmark derived for the group from its members, e.g. using the weighted average concept with market capitalization as weight. Now each group can also be thought of as an object with its constituents of stocks as its basic properties and all its measures are derived from its constituents. Any query on the group from the user's hardware or directly by user can lead to information on its constituents and vice versa. Also you may need more essential objects to represent a time series that has basic functions that apply to time series. More specifically, these functions are: first, last, maximum, minimum, moving averages, lead, lag, first difference, percent change, percentile ranking, least square regression, etc.

There is a RESET program immediately on completion of each update. This RESET program shall generate a set of REMEMBER objects waiting for the VIP objects which are the PRESENT (or DAILY, HOURLY or REAL TIME) objects that become the new reference points for comparison as per time frames. The REMEMBER objects are pre-computed to maintain system efficiency and to save computing time in the updates. The Investment Tools/Variables/Criteria are tagged as REMEMBER Variables or PRESENT Variables. The REMEMBER Variables will be tagged in advance and will wait for, the PRESENT (or DAILY, HOURLY or REAL TIME) Variables. The updates may be daily, hourly or in real-time.

### Statement of the Invention:

Therefore, a mass customizable interactive, multi-faceted system for data collection, processing, analysis, transmission, and trading in securities comprises a multidimensional database, hardware including a network of computers, software including internet browsers and software programs, wherein variables are presented to different users to allow each user to generate personalized financial product portfolio and set filters that control the presentation of information relating to their own financial news, research and/or trading. Said database is at least 3-dimensional with the dimensions of securities or tradable assets, investment tools and time factor. And said database is an upgradeable compilation of securities or tradable assets, investment tools, time factor, and additionally fourth, fifth and sixth dimensions of customers, dealers and brokers.

Said system further comprises of various components, the said components being a traded security as a first component, an investment tool of the said traded security as a second component; a third component comprises a configuration to generate a benchmark for comparison which may be updated in real time or any other frequency; an updating engine configured to update said investment tools of the traded security in real time or any other frequency.

The said engine is configured to indicate value of the said traded security against the average and automatically generating pros and cons in the form of bullish or bearish signals on whether the product is to be sold or bought and said traded security includes but is not limited to shares/stocks, ETFs (exchange traded funds), indices, commodities, currencies, options, futures, mutual funds, depository receipts and bonds.

The said investment tools includes but is not limited to new/unique investment tools including Volume Index [1 is average volume for the security], BST Arms Index (applied to Sectors or Indices), Indices of Sectors as per a common activity, Momentum, Moving Average Price increasing or decreasing, Price/Moving Average Price, Common Size Ratios as percent of Market Capitalisation, Price Percentile Rank [1 day or 6 months] in created sectors, % Discount to High, % Premium to Low, Heavyweight Market Action (with the highest rises and steepest falls of stocks that had the most influence on the sector Index), Turnover Period, Effective Yield After Tax, Moving Return, PV$1000, Created Market Value, Core Shareholding and Float, Director's Performance Indicators/Director's Score Card, Buyers' Market [with turnover or volume transacted at bid price above 50%], Sellers' Market [with turnover or volume transacted at ask price above 50%], Demand Gap or Supply Gap for Difference, Volume Weighted Price for Instant Buying or Selling, Price/Volume Weighted Price, Aggregate Depth or Depth for Top few levels, Index computations as per pro-rata allocation of market capitalisation of stocks in proportion of earnings/revenues/assets from common activities (including but not limited to Global Sector Indices, Global Round Up), Market Capitalisation divided by production or reserves. Also, user customizable or “Handshake” tools like My Price Volume Triggers, My Weighted Average Ratios [including a “Compare” feature and Sectoral/Index allocations to identify strengths and weaknesses], PV$1000 [Since Purchase], News relevant to user customized and converted from data to text. (Refer Pages 7 to 12 as well as relevant Figures for details)

Further, the said system is configured to identify and test strengths, weaknesses, opportunities and threats of the investments in the form of Bullish or Bearish Signals, Stock Reports, Sector/Index Report and Benchmarks which are updated and auto-generated in real time or any other frequency and said first component is configured to receive trading orders.

Bullish and bearish signals are generated by said investment tools on individual stocks and indices, bonds, options, futures, exchange rates, commodities, ETFs, ADRs and financial news is generated on price/volume related data in real time or at any other frequency based on fixed pre-determined criteria.

Depending on which statements are correct about a stock or security they are shown as automatically generated Bullish and Bearish Signals:

| Bullish Signals | Bearish Signals |
|---|---|
| Earnings yield of . . . exceeds 10-year | Earnings yield of . . . is below 10-year |
| bond yield of % | bond yield of % |
| Price/Earnings Ratio of . . . less than | Price/Earnings Ratio of . . . greater than |
| average of . . . for the All Ordinaries/Total | average of . . . for the All Ordinaries/Total |
| Australian market. [Top quartile by | Australian Market. [Bottom quartile by |
| value] | value] |
| Yield of . . . greater than average of . . . for | Yield of . . . lower than average of . . . for |
| the All Ordinaries/Total Australian Market | the All Ordinaries/Total Australian |
| [Top quartile by value] | market. [Bottom quartile by value] |
| Price to Book of . . . lower than average of . . . | Price to Book of . . . higher than average of . . . |
| for the All Ordinaries/Total Australian | for the All Ordinaries/Total Australian |
| Market [Top quartile by value] | Market [Bottom quartile by value] |
| Price to Sales of . . . lower than average of . . . | Price to Sales of . . . higher than average |
| for the All Ordinaries/Total Australian | of . . . for the All Ordinaries/Total |
| Market [Top quartile by value] | Australian Market [Bottom quartile by |
| | value] |
| Up on High Relative Strength | Down on Low Relative Strength |
| Up in a Sellers Market | Down in a Buyers Market |
| The price to 200-day moving average | The price to 200-day moving average |
| price is greater than 1 at . . . The moving | price is less than 1 at . . . The moving |
| average price is increasing. | average price is decreasing |

The said financial news is generated automatically by electronic means and distributed through means including emails, mobile phones, personal devices, websites, television and newspapers. The analysis of stocks is based on fixed timeframes like Since Open, 1 Day, 1 Week, 1 Month, 6 months, 1 Yr. The analysis of stocks may also be based on variable time frames.

Headlines as well as reports on securities are automatically generated on the fly or as per set criteria based on which criteria is more relevant. Types of Headlines together with a mock up of text of a news story is maintained and a Report on a stock or security is generated as per the most appropriate headline. A list of the types of headlines is shown below:

### 1. ABACUS PROPERTY GROUP HITS YEAR HIGH

### 2. GONDWANA RESOURCES HITS YEAR LOW

### 3. PALM SPRINGS UP 1.3% ON HIGH RELATIVE STRENGTH

### 4. AWB DOWN 1.0% ON LOW RELATIVE STRENGTH

### 5. TWENTY ONE BAGGER ENERGY WORLD CORPORATION CLIMBS 3.2%

### 6. THAKRAL HOLDINGS GROUP ADDS 1.5% ON EXTRAORDINARY VOLUME

### 7. THAKRAL HOLDINGS GROUP LOOSES 3.5% ON STRONG VOLUME

### 8. BOC BID ASK SPREAD HIGH AT %

### 9. BOC PRICE % BELOW VOLUME WEIGHTED PRICE

### 10. BOC PRICE % ABOVE VOLUME WEIGHTED PRICE

### 11. BUYERS MARKET CONTINUES IN BOC

### 12. BUYERS MARKET TODAY IN BOC

### 13. SELLERS MARKET CONTINUES IN BOC

### 14. SELLERS MARKET TODAY IN BOC

### 15. BHP TURNOVER VALUE SURGES AS PRICE INCREASES %

### 16. RIO TURNOVER VALUE SURGES AS PRICE DECREASES %

### 17. BHP AVERAGE TRANSACTION VALUE JUMPS

### 18. BHP TRADING IN A BUYERS MARKET AMID PRICE FALLS

### 19. BHP TRADING IN A SELLERS MARKET AMID PRICE RISE

### 20. BHP EMERGES AS A TOP LEADER TODAY

### 21. BHP EMERGES AS A TOP LAGGARD TODAY

### 22. BHP SOARS %

### 23 BHP JUMPS %

### 24. BHP CLIMBS %

### 25. BHP ADDS %

### 26. BHP PLUMMETS %

### 27. BHP TUMBLES %

28. BHP SHEDS % [Link To Trading Floor Dynamics in the text of the story]

### (Story Stays as Long as Headline Condition Remains)

### 29. BHP AGGREGATE DEMAND OUTSTRIPS AGGREGATE SUPPLY [Link To Trading Floor Depth]

### 30. BHP AGGREGATE SUPPLY OUTSTRIPS AGGREGATE DEMAND [Link To Trading Hoar Depth]

### 31. BHP DIFFERENCE POINTS TO UPSIDE [Link To Trading Floor Depth]

### 32. BHP DIFFERENCE POINTS TO DOWNSIDE [Link To Trading Floor Depth]

Note: BHP or BOC will be substituted by the ASX Code of the concerned stock based on market conditions. The BuySellTips searchlight will identify the stocks which meet certain criteria to justify the headline

### ADVANTAGES OF THE INVENTION

1. A mass customisable interactive, multi-faceted system for analysis and trading (or buying and selling) of securities.
2. Establishes a filtering and sorting system for a client on an interactive server that is actively receiving market data in real time at any other frequency. It also sets and modifies upon request filtering and sorting and reporting. Price/Volume Triggers are also set as per Page 12.
3. Provides timely access to a source of data and/or databases as a means for filtering and sorting data and retrieving valuations, identifying strengths, weaknesses, opportunities and threats, or other user information, graphs and reports; and a method that gives the user the ability to create their own Investment Tool Page and also their own page of securities. For example a user might wish to compare stocks on a yardstick of an Investment Tool. Specifically, they may wish to be alerted in real time or at any other pre-specified frequency to the highest yielding stock or the lowest P/E stock from a selected group of stocks.
4. Maintains access to data and databases to the level of service at the time of a request for service. As change keeps occurring in outside markets we need to identify, in a timely manner, what the market is doing and how it will affect a user.
5. The server is configured to allow a client to interact with a database on the system servers. Users may be provided Application Programming Interface (API) based on web services/Services Oriented Architecture (SOA); they will be able to periodically or continually access/poll the system servers.
6. Financial and securities market data (like Price, Volume, Bid, Ask etc) is processed to provide enhanced Data Presentation and Navigation. Presentation of data from the 3-Dimensional Database in the form of timely and useful tables and charts is possible. Search and filtering of the database from different perspectives any time is possible whilst relating it to current market movements. Ease of navigability is an important goal. This navigability may include international, multi-security, upstream, downstream as well as moving collaterally. With the emerging trend towards globalization, wealth-maximization and risk-minimization for individual customers takes place in a broader international context rather than it being restricted to domestic markets only.
7. The system has the facility for adding new financial products/securities. Diversification of individual portfolios is possible to provide with a flexibility of being multi-currency, multi-markets, multi-sectors together with smooth availability of information on common reference points. Collateral navigability may be from stock page to screening as per investment tool (s) or it may be from one domestic market to another market or all markets. Likewise, it may be from one sector of one market to the same sector of another market. For a stockbroker or dealer navigability may be as per key parameters on Members Pages of their clients. Selection for downstream or upstream may be from Global to Country Market to Sector (s)/Index to Stock or vice versa.
8. The database is organized according to its fundamental attributes and the data is viewed as it is stored. As and when a query is created by a customer the desired output is made available to them.
9. Multi-dimensional database achieves performance levels that are well in excess of that of relational systems performing similar data storage requirements. It generates relevant reports using minimum clicks. Apart from using a common yardstick the system uses screens in which pivots may be used for searching, comparison and ranking. The pivots may be based on stocks, time, investment tools, etc.
10. Time Series Analysis with derived variables is achieved. The system uses some fixed time frames for analyzing securities like never before. Examples include PV$1000 [1 Yr or 1 Month or 1 Week], Moving Return [1 Yr or 1 Month or 1 Week], Price Change [1 Yr or 1 Month or 1 Week], Volatility [1 Yr or 1 Month or 1 Week or 1 Day], % Discount to High [1 week or 1 month or 1 Yr], % Premium to Low [1 week, 1 month or 1 Yr], Price/Volume Weighted Price [5 days or 1 month], Price/Moving Av Price [50 days or 200 days].
11. Investment tools of each security are constantly updated in real time or at any other frequency.
12. A system that uses novel investment tools to facilitate a decision by users as to whether they should buy or sell. (Refer Pages 7 to 12). These tools address the need of investors to minimize their risks and maximize their wealth in their own individual circumstances.
13. The system is useful for comparisons, quick access to details, creating relevant sectors, identifying benchmarks of those sectors, comparing with benchmarks, measuring the variance from those benchmarks, screening and/or ranking stocks as per each benchmark criterion/investment tool etc. The averages/benchmarks are updated, preferably in real time at any other frequency, so comparisons can be accurate. A weighted average benchmark of that investment tool is computed by giving weightage as per market capitalisation of all stocks comprising the benchmark group, sector or index. A stock may comprise several sectors or indices and a benchmark of each investment tool is computed for each of these sectors or indices. Then the investment tool of each stock is compared with its sector benchmark (or with any other security) and the investment tool is shown in green if it is better than benchmark (favourable comparison) and in red if it is worse than benchmark (unfavourable comparison).
14. The system may be made available in a host of applications including computers, televisions, handheld devices, mobile phones, interactive devices, broker/dealer applications, etc. The active and interactive apparatus connecting markets to customers may be shared by them (via various communication channels including blogs, message boards, SMS text messages, emails, etc) with their advisers like Brokers/Dealers, Accountants, Lawyers, Financial Planners etc so their advice may be timely. As a direct corollary, if any of these advisers have a number of customers it is possible for those to sort and identify which of their customers may need immediate assistance/advice based on market movements. They would also be able to identify opportunities and threats that have an immediate impact on their customers enabling them to pass on timely advice to their customers using the common platform.
15. The user may input or make available data concerning their portfolio and individual circumstances (e.g. taxation bracket, loan details, etc.) which allows his/her stockbroker to have his/her data constantly monitored and market movements taken into consideration both electronically as well as physically. (Refer Handshake Tools in Page 10)
16. A method that gives the user the ability to create his own Stock Report (which may be as per a Fixed Menu) including user-customized investment tools. Different individuals use different investment strategies. As a result they choose their own investment tools which are usually different from the ones used by others. This system will provide an individual the ability to create their own stock Report comprising of investment tools selected by them. The Stock report may be obtained in electronic formats such as PDF, html, excel, csv, etc. on demand at any point of time based on current live data (Refer to sample extract in FIG. 5).
17. A facility that will allow users to receive streaming data or to access or generate, in real time (at any other frequency), the following reports electronically (e.g. PDF, html, excel, csv, etc.) or in hard copy for example:
Stock Reports (Refer FIG. 4 for Sample)
Sector Reports (Refer FIGS. 5A and 5B for Sample)
Trading Floor Depth (Refer FIGS. 6 and 6A for Sample)
Trading Floor Dynamics (Refer FIG. 7 for Sample)

The Reports include customised portions based on favourite Tools pre-stored in customer's hardware.

18. The system also provides filtered information based on pre-determined objective criterion. The filters may be pre-set on the user's hardware or may be changed at any given time. It is an intelligent way of managing the existing cheap/free raw database to make it more need-based for the reader. The signals generated by the system would help the user who is not looking for news out of sheer curiosity but with a purpose of either generating ideas for buying and selling securities or for the purpose of monitoring their portfolio. In a maze of markets and movements it is virtually impossible to identify market movements that will affect or impact a person most and will answer their need in an alert manner for:
risk minimisation and sell as soon as there are early signs or bearish signal(s) indicating downward pressure on their securities
wealth maximisation and buy when certain pre-set criteria are matched or when certain stocks in a “Watch List” throw up Bullish Signal(s).

The signals will be available in real time or at any other frequency on the internet, creating the potential for a value added round the clock service to a large customer base who might have a wide variety of investment objectives irrespective of it being a bull market or bear market. The decisions would eventually be made by the individuals based on their individual circumstances.

19. Another aspect of the invention relates to a “Handshake Mechanism” that enables constant or real-time updating of the following:
% of My Portfolio meeting Screens as per investment tools or proposed by investment experts. For example, % of My Portfolio meeting Benjamin Graham Screen 1, % of My Portfolio meeting a given screen based on criteria spelt out by investment legends. For an extended description please refer to “Handshake Tools” explained before in Page 10. The “Handshake” would enable a user to readjust their Portfolio. So if I want My Weighted Average Portfolio Yield to be X % the system would suggest a potential portfolio that would achieve that objective.
20. The system automatically generates and alerts in text XML or other forms Trading Floor News of the sort shown in FIGS. 4 and 8 based on pre-set filters/programs.

1. A mass customizable interactive, multi-faceted system for data collection, processing, analysis, transmission, and trading in securities comprising:
hardware including a network of computers;
a multidimensional database included in the network of computers; and
software including internet browsers and software programs included in the network of computers,
wherein variables are presented to different users to allow each user to generate personalized financial product portfolio and set filters that control the presentation of information relating to at least one selected from the group consisting of their own financial news, their own research and their own trading.

2. The system as claimed in claim 1, wherein said database is at least 3-dimensional with the first dimension being securities or tradable assets or sectors or indices, the second dimension being investment tools and the third dimension being time factor.

3. The system as claimed in claim 1, wherein said database is an upgradeable compilation of a first dimension of securities or tradable assets or sectors or indices, a second dimension of investment tools, a third dimension of time factor, and additionally fourth, fifth and sixth dimensions of customers, dealers and brokers, respectively.

4. The system as claimed in claim 1, said system further comprising various components, the said components being: a traded security or sector or index as a first component, an investment tool of the said traded security as a second component; a third component comprises a configuration to generate a benchmark for comparison which may be updated in real time or any other frequency; an updating engine configured to update said investment tools of the traded security in real time or any other frequency.

5. The system as claimed in claim 2, wherein the said engine is configured to indicate value of the said traded security against the average/benchmark and automatically generating pros and cons in the form of bullish or bearish signals on whether the product is to be sold or bought or held.

6. The system as claimed in claim 2 wherein said traded security includes at least one selected from the group consisting of shares, stocks, ETFs (exchange traded funds), indices, commodities, currencies, options, futures, mutual funds, depository receipts and bonds.

7. The system as claimed in claim 2, wherein the said investment tools includes at least one selected from the group consisting of new/unique investment tools including Volume Index, BST Arms Index, Indices of Sectors as per a common activity, Momentum, Moving Average Price increasing or decreasing, Price/Moving Average Price, Common Size Ratios as percent of Market Capitalisation, Price Percentile Rank in created sectors, % Discount to High, % Premium to Low, Heavyweight Market Action, Turnover Period, Effective Yield After Tax, Moving Return, PV$1000, Created Market Value, Core Shareholding and Float, Director's Performance Indicators/Director's Score Card, Buyers' Market, Sellers' Market, Demand Gap or Supply Gap for Difference, Volume Weighted Price for Instant Buying or Selling, Price/Volume Weighted Price, Aggregate Depth or Depth for Top few levels, Index computations including but not limited to Global Sector Indices as per pro-rata allocation of market capitalisation of stocks in proportion of earnings/revenues/assets from common activities, Global Round Up, Market Capitalisation divided by production or reserves, user customizable or “Handshake” tools, My Price Volume Triggers, My Weighted Average Ratios, PV$1000, and News relevant to user customized and converted from data to text.

8. The system as claimed in claim 1 wherein the said system is configured to identify and test investments in the form of at least one selected from the group consisting of Bullish or Bearish Signals, Stock Reports, Sector/Index Report and Benchmarks which are updated in real time or any other frequency.

9. The system as claimed in claim 2 wherein said first component is configured to receive trading orders.

10. The system as claimed in claim 1, wherein bullish and bearish signals are automatically generated by said investment tools on at least one selected from the group consisting of individual stocks, indices, bonds, options, futures, exchange rates, commodities, ETFs, and ADRs.

11. The system as claimed in claim 1, wherein financial news including headlines is automatically generated on price/volume related data in real time or at any other frequency based on fixed pre-determined criteria.

12. The system as in claim 11, wherein the said financial news is generated automatically by electronic means and distributed through at least one means selected from the means consisting of emails, mobile phones, personal devices, websites, television other electronic devices and newspapers.

13. The system as in claim 1, wherein the analysis of stocks is based on fixed timeframes.

14. The system as claimed in claim 1, wherein the analysis of stocks is based on fixed and/or variable time frames.

15. (canceled)
